(19) United States
(12) Patent Application Publication
(10) Pub. No.: US 2025/0246076 A1
(43) Pub. Date: Jul. 31, 2025

(54) METHOD AND SYSTEM

(71) Applicant: TOYOTA JIDOSHA KABUSHIKI KAISHA, Toyota-shi Aichi-ken (JP)

(72) Inventors: Toshiki KASHIWAKURA, Ota-ku Tokyo-to (JP); Chihiro INABA, Nerima-ku Tokyo-to (JP); Tsuyoshi OKADA, Nagoya-shi Aichi-ken (JP); Yasuhiro KOBATAKE, Nagoya-shi Aichi-ken (JP)

(73) Assignee: TOYOTA JIDOSHA KABUSHIKI KAISHA, Toyota-shi Aichi-ken (JP)

(21) Appl. No.: 19/039,341

(22) Filed: Jan. 28, 2025

(30) Foreign Application Priority Data
Jan. 31, 2024 (JP) 2024-013572

(51) Int. Cl. G08G 1/16; G06V 20/54; G06V 40/10

(52) U.S. Cl. CPC G08G 1/164; G06V 20/54; G06V 40/10; G08G 1/166

(57) ABSTRACT

Upon receiving a notification from a roadside apparatus, a terminal apparatus identifies a positional relationship of the roadside apparatus relative to a travel route of an automated driving vehicle associated with the terminal apparatus. The terminal apparatus then outputs the notification in a manner according to the identified positional relationship.

### CROSS-REFERENCE TO RELATED APPLICATION

This application claims priority to Japanese Patent Application No. 2024-013572 filed on Jan. 31, 2024, the entire contents of which are incorporated herein by reference.

### TECHNICAL FIELD

The present disclosure relates to a method and a system.

### BACKGROUND

Technology for assisting target persons, such as pedestrians and drivers or driving assistants of vehicles, with traffic information is conventionally known. For example, technology for warning vehicles turning right or left at an intersection that there is a vehicle parked dangerously on a road near the intersection is disclosed.

### CITATION LIST

### Patent Literature

PTL 1: JP 2017-182409 A

### SUMMARY

It is desired to improve technology for assisting target persons with traffic information.

It would be helpful to improve technology for assisting target persons with traffic information.

A method according to an embodiment of the present disclosure is a method performed by a terminal apparatus configured to be able to communicate with multiple roadside apparatuses, the method including:
upon receiving a notification from a roadside apparatus, identifying a positional relationship of the roadside apparatus relative to a travel route of an automated driving vehicle associated with the terminal apparatus; and
outputting the notification in a manner according to the identified positional relationship.

A system according to an embodiment of the present disclosure is a system including:
a terminal apparatus; and
a roadside apparatus,
wherein
the roadside apparatus is configured to transmit a notification to the terminal apparatus, upon detecting a person from video of a camera provided in the roadside apparatus, and
the terminal apparatus is configured to, upon receiving the notification from the roadside apparatus, identify a positional relationship of the roadside apparatus relative to a travel route of an automated driving vehicle associated with the terminal apparatus, and output the notification in a manner according to the identified positional relationship.

According to an embodiment of the present disclosure, technology for assisting target persons with traffic information is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of a roadside apparatus;

FIG. 4 is a block diagram illustrating a schematic configuration of an information processing apparatus;

FIG. 5 is a flowchart illustrating operations of the terminal apparatus according to the embodiment; and

FIG. 6 is a diagram illustrating an example of a positional relationship between an automated driving vehicle and each of two roadside apparatuses according to the embodiment.

### DETAILED DESCRIPTION

Hereinafter, an embodiment of the present disclosure will be described.

### Outline of Embodiment

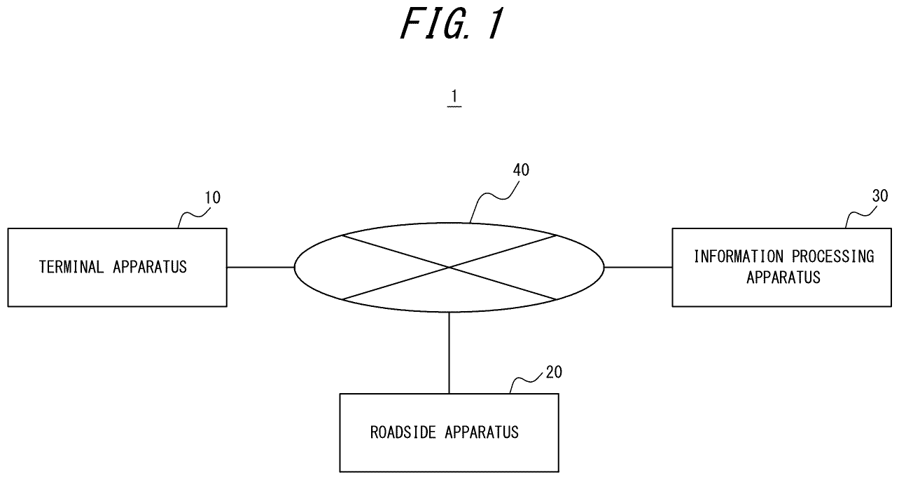

An outline of a system 1 according to the embodiment of the present disclosure will be described with reference to FIG. 1. The system 1 includes a terminal apparatus 10, a roadside apparatus 20, and an information processing apparatus 30. The terminal apparatus 10, the roadside apparatus 20, and the information processing apparatus 30 are communicably connected to a network 40 including, for example, a mobile communication network, the Internet, or the like.

The terminal apparatus 10 is a computer, such as a personal computer (PC), a smartphone, or a tablet terminal, for example. In the present embodiment, the terminal apparatus 10 is used by a driving assistant of an automated driving vehicle that is capable of automated driving such as any one of Levels 1 to 5 as defined by the Society of Automotive Engineers (SAE), for example. The automated driving vehicle is capable of automated driving at Level 3 or 4, and the driving assistant can override driving operations on board the automated driving vehicle or remotely. The terminal apparatus 10 may be a computer installed in the automated driving vehicle. The system 1 may include any number of one or more terminal apparatuses 10.

The roadside apparatus 20 is installed in the vicinity of, for example, an intersection, a crosswalk, or the like. In the present embodiment, the roadside apparatus 20 can detect, from video of a camera provided therein, persons heading toward a roadway, as pedestrians who are about to cross the roadway. Upon detecting a pedestrian who is about to cross the roadway, the roadside apparatus 20 provides assistance with traffic information, by notifying predetermined information to the pedestrian and the terminal apparatus 10 that a driver or driving assistant of an automated driving vehicle that is approaching the roadside apparatus 20 uses. The system 1 may include any number of one or more roadside apparatuses 20.

The information processing apparatus 30 is one computer or a plurality of computers that can communicate with each other. The information processing apparatus 30 can communicate with each terminal apparatus 10 and each roadside apparatus 20 via the network 40. In the present embodiment, the communication between the terminal apparatus 10 and the roadside apparatus 20 may be conducted via the information processing apparatus 30. The information processing apparatus 30 communicates with each terminal apparatus 10, and continuously acquires vehicle information including, for example, the position of an automated driving vehicle associated with the terminal apparatus 10.

First, an outline of the present embodiment will be described, and details thereof will be described later. Upon receiving a notification from a roadside apparatus 20, a terminal apparatus 10 identifies a positional relationship of the roadside apparatus 20 relative to a travel route of an automated driving vehicle associated with the terminal apparatus 10. The terminal apparatus 10 then outputs the notification in a manner according to the identified positional relationship.

As a comparative example of the present embodiment, for example, consider that roadside apparatuses 20 are installed on both the left and right sides with respect to a travel route of an automated driving vehicle, and that a terminal apparatus 10 simply outputs a notification received from a roadside apparatus 20 that has detected a pedestrian. In such a comparative example, a driving assistant of the automated driving vehicle may not immediately recognize from which of the left and right sides with respect to the travel route the notified pedestrian is about to cross the roadway.

In contrast, according to the present embodiment, as described above, a notification from a roadside apparatus 20 is output in a manner according to a positional relationship of the roadside apparatus 20 relative to a travel route of an automated driving vehicle. Therefore, a driving assistant of the automated driving vehicle using a terminal apparatus 10 can immediately recognize what positional relationship the roadside apparatus 20, from which the notification is transmitted, has with respect to the travel route. Thus, according to the present embodiment, technology for assisting target persons with traffic information is improved in terms of increasing recognition that from which of the left and right sides with respect to the travel route the notified pedestrian is about to cross the roadway.

Next, configurations of the system 1 will be described in detail.

### (Configuration of Terminal Apparatus)

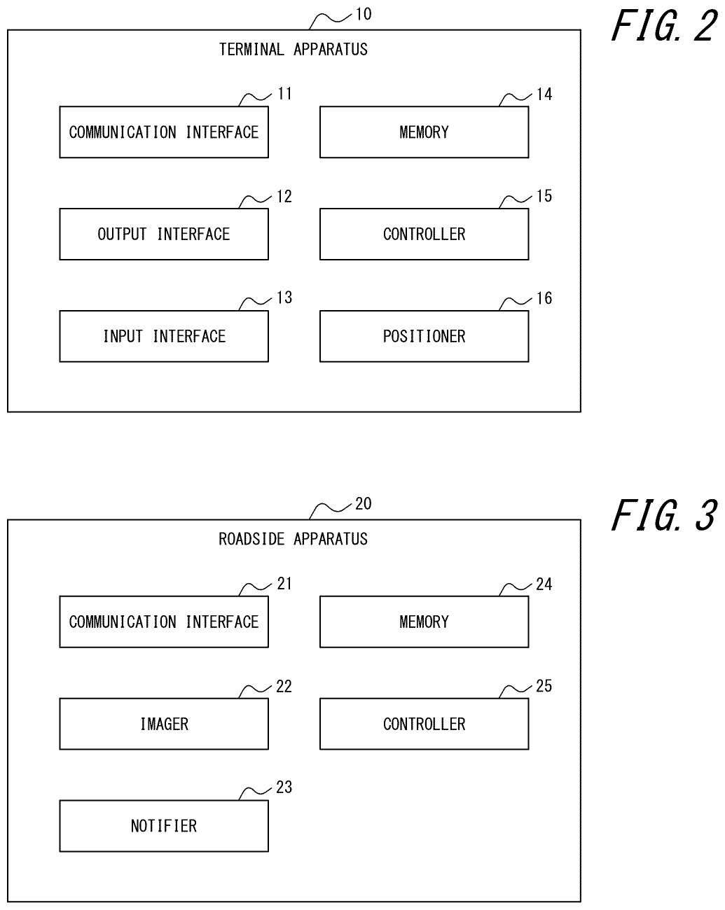

As illustrated in FIG. 2, each terminal apparatus 10 includes a communication interface 11, an output interface 12, an input interface 13, a memory 14, a controller 15, and a positioner 16.

The communication interface 11 includes at least one communication interface for connecting to the network 40. The communication interface is compliant with a mobile communication standard such as the 4th generation (4G) standard or the 5th generation (5G) standard, for example, but is not limited to these. In the present embodiment, the terminal apparatus 10 communicates with the information processing apparatus 30 via the communication interface 11 and the network 40.

The output interface 12 includes at least one output device for outputting information. The output device is, for example, a display for outputting information as video, a speaker for outputting information as audio, or the like, but is not limited to these. Alternatively, the output interface 12 may include an interface for connecting to an external output device.

The input interface 13 includes at least one input device for detecting an input operation by a user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device.

The memory 14 includes one or more memories. The memories are, for example, semiconductor memories, magnetic memories, optical memories, or the like, but are not limited to these. The memories included in the memory 14 may each function as, for example, a main memory, an auxiliary memory, or a cache memory. The memory 14 stores any information to be used for operations of the terminal apparatus 10. For example, the memory 14 may store identification information on an automated driving vehicle associated with the terminal apparatus 10. For example, the memory 14 may store a system program, an application program, embedded software, or the like. The information stored in the memory 14 may be updated with, for example, information acquired from the network 40 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the terminal apparatus 10 or automated driving vehicle.

The positioner 16 includes at least one device for acquiring positional information on the terminal apparatus 10. Specifically, the positioner 16 is, for example, a position sensor corresponding to a global positioning system (GPS) or the like, a geomagnetic sensor, a velocity sensor, an acceleration sensor, a gyro sensor, or the like, but is not limited to these and may be any sensor. One or more sensors that are provided in the automated driving vehicle for use in control over the automated driving vehicle may include the positioner 16.

### (Configuration of Roadside Apparatus)

As illustrated in FIG. 3, each roadside apparatus 20 includes a communication interface 21, an imager 22, a notifier 23, a memory 24, and a controller 25.

The communication interface 21 includes at least one communication interface for connecting to the network 40. The communication interface is compliant with, for example, a mobile communication standard or a wireless local area network (LAN) standard, but not limited to these and may be compliant with any communication standard. In the present embodiment, the roadside apparatus 20 communicates with the information processing apparatus 30 via the communication interface 21 and the network 40.

The imager 22 includes one or more cameras that can image its surroundings. In the present embodiment, the roadside apparatus 20 is installed in the vicinity of the boundary between a sidewalk and a roadway, for example, so that the imager 22 can image pedestrians moving from the sidewalk toward the roadway.

The notifier 23 includes one or more notification devices that notify pedestrians nearby of information. The notification devices are, for example, speakers, electronic bulletin boards, displays, or the like, but are not limited to these and may be any notification devices.

The memory 24 includes one or more memories. The memories included in the memory 24 may each function as, for example, a main memory, an auxiliary memory, or a cache memory. The memory 24 stores any information to be used for operations of the roadside apparatus 20. For example, the memory 24 may store a system program, an application program, embedded software, map information, and the like. The information stored in the memory 24 may be updated with, for example, information acquired from the network 40 via the communication interface 21.

The controller 25 includes at least one processor, at least one programmable circuit, at least one dedicated circuit, or a combination of these. The controller 25 controls operations of the entire roadside apparatus 20.

### (Configuration of Information Processing Apparatus)

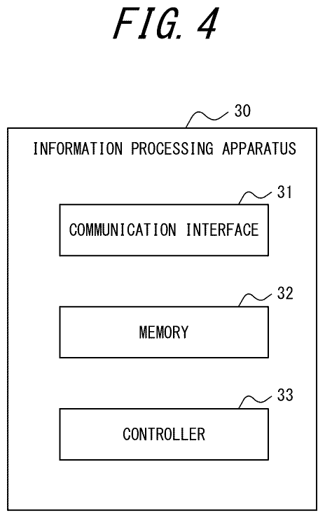

As illustrated in FIG. 4, the information processing apparatus 30 includes a communication interface 31, a memory 32, and a controller 33.

The communication interface 31 includes at least one communication interface for connecting to the network 40. The communication interface is compliant with a wired LAN standard or a wireless LAN standard, for example, but is not limited to these, and may be compliant with any communication standard. In the present embodiment, the information processing apparatus 30 communicates with the terminal apparatus 10 and the roadside apparatus 20 via the communication interface 31 and the network 40.

The memory 32 includes one or more memories. The memories included in the memory 32 may each function as, for example, a main memory, an auxiliary memory, or a cache memory. The memory 32 stores any information to be used for operations of the information processing apparatus 30. For example, the memory 32 may store identification information on an automated driving vehicle associated with each terminal apparatus 10. For example, the memory 32 may store a system program, an application program, embedded software, map information, and the like. The information stored in the memory 32 may be updated with, for example, information acquired from the network 40 via the communication interface 31.

The controller 33 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 33 controls the operations of the entire information processing apparatus 30.

### (Flow of Operations of Terminal Apparatus)

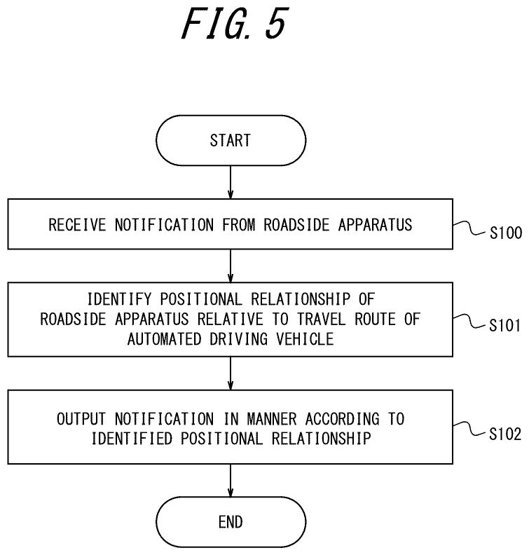

Operations of each terminal apparatus 10 according to the present embodiment will be described with reference to FIG. 5.

S100: The controller 15 of the terminal apparatus 10 receives a notification from a roadside apparatus 20.

Specifically, the controller 25 of the roadside apparatus 20 transmits a notification to the terminal apparatus 10 associated with an automated driving vehicle that exists within a predetermined range, upon detecting, from video of a camera installed in the roadside apparatus 20, a pedestrian who is about to cross a roadway. The controller 15 receives the notification via the communication interface 11. The controller 15 may receive the notification from the information processing apparatus 30 via the communication interface 11.

The pedestrian who is about to cross the roadway may be detected, based on the video of the camera provided in the roadside apparatus 20, by the roadside apparatus 20 or the information processing apparatus 30. Specifically, the controller 25 or the controller 33 determines whether there is a person in the video. When a person is present, the controller 25 or the controller 33 detects the person, as a pedestrian moving toward the roadway, depending on a change in the position of the person.

The “pedestrian” may include not only one who walks on feet, but also one who uses a two-wheel vehicle, a wheelchair, or other mobile objects. The “pedestrian” does not necessarily have to be moving and may include, for example, a person who is likely to be moving. The “pedestrian” does not necessarily have to be a person, but may in some cases be an animal, such as a dog or a deer, for example.

Whether the automated driving vehicle is within the predetermined range can be determined, for example, by whether the distance between the automated driving vehicle and the roadside apparatus 20 is within a predetermined distance, or whether time remaining before the automated driving vehicle passes by the roadside apparatus 20 is within predetermined time, but may be determined based on any conditions, not limited to these. The determination may be made, based on positional information on the automated driving vehicle and positional information on the roadside apparatus 20, by the roadside apparatus 20 or the information processing apparatus 30.

The “predetermined distance” can be any distance, including 100 m, 200 m, 500 m, 1 km, 2 km, 5 km, 10 km, and the like. The predetermined distance may be changeable.

The “predetermined time” is, for example, 10 seconds, but is not limited to this and can be any arbitrary time. The predetermined time may be changeable.

The notification from the roadside apparatus 20 may include any information, such as the positional information on the roadside apparatus 20 or information on the pedestrian detected by the roadside apparatus 20.

S101: The controller 15 identifies a positional relationship of the roadside apparatus 20 relative to a travel route of the automated driving vehicle associated with the terminal apparatus 10.

Specifically, the controller 15 acquires a travel route of the automated driving vehicle stored in the memory 14, or acquires a travel route by route search based on a destination of the automated driving vehicle stored in the memory 14. The controller 15 then identify a positional relationship of the roadside apparatus 20 relative to the travel route of the automated driving vehicle, using the travel route and the positional information on the roadside apparatus 20.

The “positional relationship” refers to a positional relationship such as, for example, the roadside apparatus 20 is installed on the right side with respect to the travel route of the automated driving vehicle, or the roadside apparatus 20 is installed on the right side at an angle of 45 degrees with respect to the travel route of the automated driving vehicle. The positional relationship may be indicated by coordinates centered on the automated driving vehicle.

When the notification does not include the positional information on the roadside apparatus 20, the controller 15 may transmit, before performing S101, a request for acquiring the positional information on the roadside apparatus 20 to the roadside apparatus 20 via the communication interface 21 and receive the positional information on the roadside apparatus 20, which is transmitted from the roadside apparatus 20 in response to the request, via the communication interface 11. Alternatively, the controller 15 may transmit a request for acquiring the positional information on the roadside apparatus 20 to the information processing apparatus 30. In this case, the controller 15 may receive the positional information on the roadside apparatus 20, which is transmitted from the information processing apparatus 30 in response to the request, via the communication interface 11.

S102: The controller 15 outputs the notification in a manner according to the identified positional relationship.

Specifically, for example, when the roadside apparatus 20 is installed on the left side with respect to the travel route of the automated driving vehicle, the controller 15 displays the notification on the left side of a display of the output interface 12. When the roadside apparatus 20 is installed on the right side with respect to the travel route of the automated driving vehicle, the controller 15 displays the notification on the right side of the display of the output interface 12.

For example, the controller 15 may output the notification using a speaker of the output interface 12. Specifically, for example, when the roadside apparatus 20 is installed on the left side with respect to the travel route of the automated driving vehicle, the controller 15 audibly outputs, using a speaker of the output interface 12, that the notification is from the left side. When the roadside apparatus 20 is installed on the right side with respect to the travel route of the automated driving vehicle, the controller 15 audibly outputs, using the speaker of the output interface 12, that the notification is from the right side.

Alternatively, when the roadside apparatus 20 is installed on the left side with respect to the travel route of the automated driving vehicle, the controller 15 audibly outputs the notification using a speaker installed on the left side in the automated driving vehicle. When the roadside apparatus 20 is installed on the right side with respect to the travel route of the automated driving vehicle, the controller 15 audibly outputs the notification using a speaker installed on the right side in the automated driving vehicle. The controller 15 may also output the notification using the display and the speaker(s) simultaneously.

For example, the controller 15 may output the notification in a manner according to a more specific positional relationship identified. Specifically, for example, when the positional relationship is indicated by coordinates centered on the automated driving vehicle, the controller 15 may display the notification at a position corresponding to the coordinates on the display of the output interface 12.

The “manner according to the positional relationship” may include indication in different colors or indication in different color densities, but may include various manners, not limited to these. The “manner according to the positional relationship” may include output in different sounds and/or in different volumes.

As described above, upon receiving a notification from a roadside apparatus 20, a terminal apparatus 10 according to the present embodiment identifies a positional relationship of the roadside apparatus 20 relative to a travel route of an automated driving vehicle associated with the terminal apparatus 10. The terminal apparatus 10 then outputs the notification in a manner according to the identified positional relationship.

According to such a configuration, as described above, a notification from a roadside apparatus 20 is output in a manner according to a positional relationship of the roadside apparatus 20 relative to a travel route of an automated driving vehicle. Therefore, a driving assistant of the automated driving vehicle using a terminal apparatus 10 can immediately recognize what positional relationship the roadside apparatus 20, from which the notification is transmitted, has with respect to the travel route. Thus, according to the present embodiment, technology for assisting target persons with traffic information is improved in terms of increasing recognition that from which of the left and right sides with respect to the travel route the notified pedestrian is about to cross the roadway.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, an embodiment in which some operations performed by the terminal apparatus 10 in the embodiment described above are performed by the roadside apparatus 20 and/or the information processing apparatus 30 is also possible. An embodiment in which some operations performed by the roadside apparatus 20 are performed by the terminal apparatus 10 and/or the information processing apparatus 30 is also possible. An embodiment in which some operations performed by the information processing apparatus 30 are performed by the terminal apparatus 10 and/or the roadside apparatus 20 is also possible.

For example, in the embodiment described above, upon receiving two or more notifications from two or more roadside apparatuses 20, respectively, the controller 15 may output the two or more notifications in order that is determined based on the distance from the automated driving vehicle to each of the two or more roadside apparatuses 20.

For example, specifically, upon receiving two or more notifications from two or more roadside apparatuses 20, respectively, the controller 15 may display the two or more notifications side by side in a vertical direction or a horizontal direction on the display of the output interface 12, in increasing order of the distance from the automated driving vehicle to each of the two or more roadside apparatuses 20. The controller 15 may display the two or more notifications in different colors and/or different color densities on the display of the output interface 12, depending on the distance from the automated driving vehicle to each of the two or more roadside apparatuses 20.

Alternatively, upon receiving two or more notifications from two or more roadside apparatuses 20, respectively, the controller 15 may audibly output, using the speaker of the output interface 12, the two or more notifications in increasing order of the distance from the automated driving vehicle to each of the two or more roadside apparatuses 20. The controller 15 may output the two or more notifications in different volumes and/or different sounds, depending on the distance from the automated driving vehicle to each of the two or more roadside apparatuses 20.

For example, in the embodiment described above, upon receiving two or more notifications from two or more roadside apparatuses 20, respectively, the controller 15 may output only one or more notifications that are selected, from among the two or more notifications, based on a driving situation of the automated driving vehicle and a positional relationship of each of the two or more roadside apparatuses 20 relative to the travel route of the automated driving vehicle.

The “driving situation” includes, for example, the automated driving vehicle going straight ahead, stopping, turning left, and turning right, but may include any driving situations of the automated driving vehicle, not limited to these.

Specifically, for example, when the driving situation of the automated driving vehicle is straight ahead, the controller 15 may output only one or more notifications from, among the two or more roadside apparatuses 20, one or more roadside apparatuses 20 located on either one of the left and right sides with respect to the travel route of the automated driving vehicle.

For example, when the driving situation of the automated driving vehicle is straight ahead and drivers keep to the left side of the road, the controller 15 may output only one or more notifications from, among the two or more roadside apparatuses 20, one or more roadside apparatuses 20 located on the left side with respect to the travel route of the automated driving vehicle.

Alternatively, for example, when the driving situation of the automated driving vehicle is straight ahead and drivers keep to the right side of the road, the controller 15 may output only one or more notifications from, among the two or more roadside apparatuses 20, one or more roadside apparatuses 20 located on the right side with respect to the travel route of the automated driving vehicle.

Alternatively, for example, when the driving situation of the automated driving vehicle is a right turn, the controller 15 may output only one or more notifications from, among the two or more roadside apparatuses 20, one or more roadside apparatus 20 located on the right side with respect to the travel route of the automated driving vehicle.

Alternatively, for example, when the driving situation of the automated driving vehicle is a left turn, the controller 15 may output only one or more notifications from, among the two or more roadside apparatuses 20, one or more roadside apparatus 20 located on the left side with respect to the travel route of the automated driving vehicle.

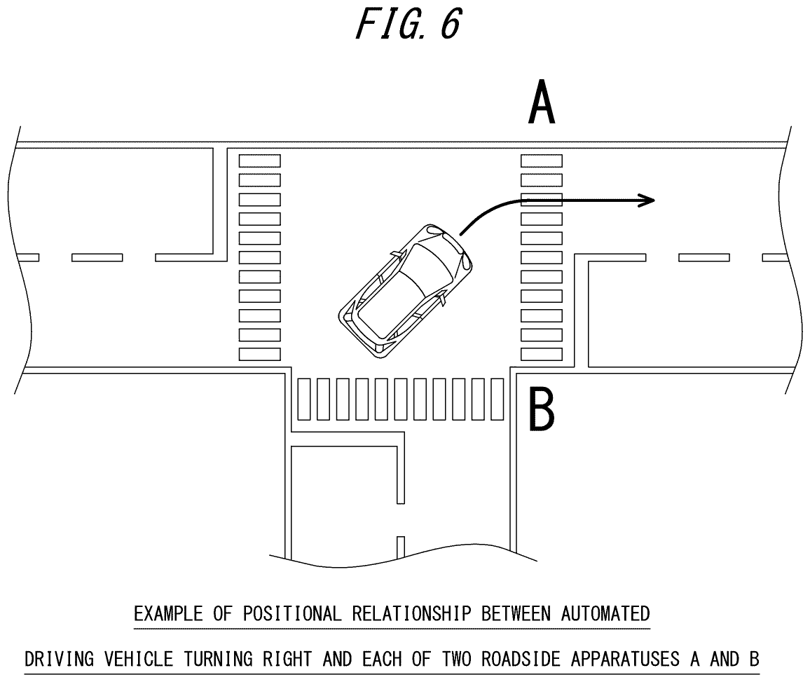

A specific example of the variation described above will be described using the example of FIG. 6, in which two roadside apparatuses 20 are installed at a T-junction on a Japanese road. In FIG. 6, the two roadside apparatuses 20 are referred to as roadside apparatuses A and B, and an automated driving vehicle is making a right turn at the T-junction. In such a case, the controller 15 outputs only a notification from the roadside apparatus B, which has poor visibility, and does not output a notification from the roadside apparatus A, which has good visibility. This is because it is relatively easy for the driving assistant to see around the roadside apparatus A located in front of the automated driving vehicle (the left side of the travel route), while it is relatively difficult for the driving assistant to see around the roadside apparatus B located on the right side of the automated driving vehicle (the right side of the travel route).

Depending on a driving situation, a too much amount of information notified may adversely affect the determination of a driving assistant. According to such a variation, it is possible to adjust, depending on a driving situation, the amount of information to be notified to a driving assistant. In addition, although collisions involving other vehicles or pedestrians are generally likely to occur when vehicles are making turns, such as left turns or right turns, the use of such a variation can prevent the occurrence of such collisions.

For example, the controller 15 may perform the variation described above only when the number of two or more notifications is greater than or equal to a specified number.

The “specified number” is an arbitrary integer. The specified number may be changeable.

For example, in the variation described above, the controller 15 may not output only one or more notifications that are selected, from among the two or more notifications, based on a driving situation of the automated driving vehicle and a positional relationship of each of the two or more roadside apparatuses 20 relative to the travel route of the automated driving vehicle, but may output the selected one or more notifications in a manner different from the others.

A specific example will be described using again the example of FIG. 6, in which two roadside apparatuses 20 are installed at a T-junction on a Japanese road. In FIG. 6, the two roadside apparatuses 20 are referred to as roadside apparatuses A and B, and an automated driving vehicle is making a right turn at the T-junction. Suppose that the controller 15 displays notifications from the two roadside apparatuses 20 in black letters on the display of the output interface 12 when the driving situation of the automated driving vehicle is other than a right turn. In such a case, the controller 15 displays a notification from the roadside apparatus B in red letters, and displays a notification from the roadside apparatus A in black letters.

For example, in the embodiment described above, the controller 15 may output only one or more notifications from one or more roadside apparatuses 20 that satisfy an output condition, which can be set in the terminal apparatus 10 based on a positional relationship of each of the roadside apparatuses 20 relative to the travel route of the automated driving vehicle, and may not output one or more notifications from one or more roadside apparatuses 20 that do not satisfy the output condition.

Specifically, for example, when a user, using the input interface 13 of the terminal apparatus 10, turns on a first output condition that a roadside apparatus 20 is installed on the left side with respect to the travel route of the automated driving vehicle and turns off a second output condition that a roadside apparatus 20 is installed on the right side with respect to the travel route of the automated driving vehicle, the controller 15 outputs one or more notifications from one or more roadside apparatuses 20 installed on the left side with respect to the travel route of the automated driving vehicle and does not output one or more notifications from one or more roadside apparatuses 20 installed on the right side with respect to the travel route of the automated driving vehicle.

The “output condition” may include not only a positional relationship of a roadside apparatus 20 relative to the travel route of the automated driving vehicle, such as the first and second output conditions described above, but also any other conditions, such as the distance between the automated driving vehicle and a roadside apparatus 20 being within a predetermined distance, e.g., 5 meters, or the time remaining before the automated driving vehicle passes by a roadside apparatus 20 being within predetermined time, e.g., 5 seconds. There may be more output conditions, other than the first and second output conditions. Each output condition may be switchable between ON and OFF.

In the embodiment described above, the controller 25 of the roadside apparatus 20 may transmit the notification to the terminal apparatus 10 of the automated driving vehicle upon satisfying a notification condition, which can be set in the roadside apparatus 20 based on a positional relationship of the roadside apparatus 20 relative to the travel route of the automated driving vehicle, and may not transmit the notification to the terminal apparatus 10 upon not satisfying the notification condition.

Specifically, for example, suppose that in each roadside apparatus 20, a first notification condition that the roadside apparatus 20 is installed on the left side with respect to a travel route of an automated driving vehicle is turned on, and a second notification condition that the roadside apparatus 20 is installed on the right side with respect to a travel route of an automated driving vehicle is turned off. In this case, when an automated driving vehicle travels in the direction of roadside apparatuses 20, one or more roadside apparatuses 20 that are installed on the left side with respect to a travel route of the automated driving vehicle transmit the notification(s) to the terminal apparatus 10, and one or more roadside apparatuses 20 that are installed on the right side with respect to the travel route of the automated driving vehicle do not transmit the notification(s) to the terminal apparatus 10.

The “notification condition” may include not only a positional relationship of the roadside apparatus 20 relative to a travel route of an automated driving vehicle, such as the first and second notification conditions described above, but also any other conditions, such as the distance between the automated driving vehicle and the roadside apparatus 20 being within a predetermined distance, e.g., 5 meters, or the time remaining before the automated driving vehicle passes by the roadside apparatus 20 being within predetermined time, e.g., 5 seconds. There may be more notification conditions, other than the first and second notification conditions. Each notification condition may be switchable between ON and OFF.

In the embodiment described above, the notification from the roadside apparatus 20 may include information on the pedestrian detected from the video of the camera installed in the roadside apparatus 20, and the controller 15 may output the notification in a manner according to the information on the pedestrian.

Specifically, upon detecting a pedestrian detected from video of the camera installed in the roadside apparatus 20 in the process described in S100, the controller 25 of the roadside apparatus 20 acquires any information regarding the pedestrian, which may include, but is not limited to, for example, the number of pedestrians, a state of the pedestrian, or an age group of the pedestrian. The controller 25 then transmits, to the terminal apparatus 10, a notification including the information on the pedestrian.

The “state of the pedestrian” includes that the pedestrian is walking at the moment and that the person is stationary at the moment, but may include any states of the pedestrian, not limited to these.

The “age group of the pedestrian” includes, for example, whether the pedestrian is a child, an adult, or an elderly person, but may be any information that identifies the age group of the pedestrian, not limited to these.

The controller 25 acquires the information on the pedestrian based on the video of the camera installed in the roadside apparatus 20. For example, when the information on the pedestrian includes the state of the pedestrian, the controller 25 may acquire the information on the pedestrian by determining the state of the pedestrian based on a change in the pedestrian's position. The controller 25 may also use AI to acquire the information on the pedestrian.

These processes may be performed by the controller 33 of the information processing apparatus 30.

Upon receiving the notification including the information on the pedestrian, the controller 15 outputs the notification in a manner according to the information on the pedestrian.

The “manner according to the information on the pedestrian” may include indication in different colors, e.g., red, blue, and yellow, indication in different shapes, e.g., a circle and a double circle, indication in different letters, output in different sounds, and the like, but may include various manners not limited to these.

For example, an embodiment in which a general purpose computer functions as the terminal apparatus 10 according to the above embodiment can also be implemented. Specifically, a program in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1]A method performed by a terminal apparatus configured to be able to communicate with multiple roadside apparatuses, the method comprising:
upon receiving a notification from a roadside apparatus, identifying a positional relationship of the roadside apparatus relative to a travel route of an automated driving vehicle associated with the terminal apparatus; and
outputting the notification in a manner according to the identified positional relationship.

[Appendix 2] The method according to appendix 1, wherein the outputting of the notification includes, when the terminal apparatus receives two or more notifications from two or more roadside apparatuses, respectively, outputting the two or more notifications in order that is determined based on a distance from the automated driving vehicle to each of the two or more roadside apparatuses.

[Appendix 3] The method according to appendix 2, wherein the outputting of the two or more notifications includes displaying the two or more notifications side by side in a vertical direction or a horizontal direction on a screen of the terminal apparatus, in increasing order of the distance from the automated driving vehicle to each of the two or more roadside apparatuses.

[Appendix 4] The method according to appendix 2 or 3, wherein the outputting of the two or more notifications includes audibly outputting the two or more notifications in increasing order of the distance from the automated driving vehicle to each of the two or more roadside apparatuses.

[Appendix 5] The method according to appendix 1, wherein the outputting of the notification includes, when the terminal apparatus receives two or more notifications from two or more roadside apparatuses, respectively, outputting only a notification that is selected, from among the two or more notifications, based on a driving situation of the automated driving vehicle and a positional relationship of each of the two or more roadside apparatuses relative to the travel route.

[Appendix 6] The method according to appendix 5, wherein the outputting of only the selected notification includes, when the driving situation of the automated driving vehicle is straight ahead, outputting only a notification from, among the two or more roadside apparatuses, a roadside apparatus located on either one of left and right sides with respect to the travel route of the automated driving vehicle.

[Appendix 7] The method according to appendix 5 or 6, wherein the outputting of only the selected notification includes, when the driving situation of the automated driving vehicle is a right turn, outputting only a notification from, among the two or more roadside apparatuses, a roadside apparatus located on a right side with respect to the travel route of the automated driving vehicle.

[Appendix 8] The method according to any one of appendices 1 to 7, wherein the outputting of the notification includes displaying only a notification from a roadside apparatus that satisfies an output condition that can be set in the terminal apparatus based on a positional relationship of the roadside apparatus relative to the travel route of the automated driving vehicle, and not outputting a notification from a roadside apparatus that does not satisfy the output condition.

[Appendix 9] The method according to any one of appendices 1 to 8, wherein the output condition that can be set in the terminal apparatus includes a first output condition that a roadside apparatus is installed on a left side with respect to the travel route of the automated driving vehicle, and a second output condition that a roadside apparatus is installed on a right side with respect to the travel route of the automated driving vehicle.

[Appendix 10] The method according to any one of appendices 1 to 9, wherein
the notification from the roadside apparatus includes information on a pedestrian detected from video of a camera provided in the roadside apparatus, and
the method further comprises outputting the notification in a manner according to the information on the pedestrian.

[Appendix 11]A system comprising:
a terminal apparatus; and
a roadside apparatus,
wherein
the roadside apparatus is configured to transmit a notification to the terminal apparatus, upon detecting, from video of a camera provided in the roadside apparatus, a pedestrian who is about to cross a roadway, and
the terminal apparatus is configured to, upon receiving the notification from the roadside apparatus, identify a positional relationship of the roadside apparatus relative to a travel route of an automated driving vehicle associated with the terminal apparatus, and output the notification in a manner according to the identified positional relationship.

[Appendix 12] The system according to appendix 11, wherein the terminal apparatus is configured to, upon receiving two or more notifications from two or more roadside apparatuses, respectively, output the two or more notifications in order that is determined based on a distance from the automated driving vehicle to each of the two or more roadside apparatuses.

[Appendix 13] The system according to appendix 12, wherein the terminal apparatus is configured to display the two or more notifications side by side in a vertical direction or a horizontal direction on a screen of the terminal apparatus, in increasing order of the distance from the automated driving vehicle to each of the two or more roadside apparatuses.

[Appendix 14] The system according to appendix 12 or 13, wherein the terminal apparatus is configured to audibly output the two or more notifications in increasing order of the distance from the automated driving vehicle to each of the two or more roadside apparatuses.

[Appendix 15] The system according to appendix 11, wherein the terminal apparatus is configured to, upon receiving two or more notifications from two or more roadside apparatuses, respectively, output only a notification that is selected, from among the two or more notifications, based on a driving situation of the automated driving vehicle and a positional relationship of each of the two or more roadside apparatuses relative to the travel route.

[Appendix 16] The system according to appendix 15, wherein when the driving situation of the automated driving vehicle is straight ahead, the terminal apparatus is configured to output only a notification from, among the two or more roadside apparatuses, a roadside apparatus located on either one of left and right sides with respect to the travel route of the automated driving vehicle.

[Appendix 17] The system according to appendix 15 or 16, wherein when the driving situation of the automated driving vehicle is a right turn, the terminal apparatus is configured to output only a notification from, among the two or more roadside apparatuses, a roadside apparatus located on a right side with respect to the travel route of the automated driving vehicle.

[Appendix 18] The system according to any one of appendices 11 to 17, wherein the roadside apparatus is configured to transmit the notification to the automated driving vehicle when the roadside apparatus satisfies a notification condition that can be set in the roadside apparatus based on a positional relationship of the roadside apparatus relative to the travel route of the automated driving vehicle, and not to transmit the notification when the roadside apparatus does not satisfy the notification condition.

[Appendix 19] The system according to any one of appendices 11 to 18, wherein the notification condition that can be set in the roadside apparatus includes a first notification condition that a roadside apparatus is installed on a left side with respect to the travel route of the automated driving vehicle, and a second notification condition that a roadside apparatus is installed on a right side with respect to the travel route of the automated driving vehicle.

[Appendix 20] The system according to any one of appendices 11 to 19, wherein
the notification includes information on the pedestrian, and
the terminal apparatus is configured to output the notification in a manner according to the information on the pedestrian.

1. A method performed by a terminal apparatus configured to be able to communicate with multiple roadside apparatuses, the method comprising:
upon receiving a notification from a roadside apparatus, identifying a positional relationship of the roadside apparatus relative to a travel route of an automated driving vehicle associated with the terminal apparatus; and
outputting the notification in a manner according to the identified positional relationship.

2. The method according to claim 1, wherein the outputting of the notification includes, when the terminal apparatus receives two or more notifications from two or more roadside apparatuses, respectively, outputting the two or more notifications in order that is determined based on a distance from the automated driving vehicle to each of the two or more roadside apparatuses.

3. The method according to claim 2, wherein the outputting of the two or more notifications includes displaying the two or more notifications side by side in a vertical direction or a horizontal direction on a screen of the terminal apparatus, in increasing order of the distance from the automated driving vehicle to each of the two or more roadside apparatuses.

4. The method according to claim 2, wherein the outputting of the two or more notifications includes audibly outputting the two or more notifications in increasing order of the distance from the automated driving vehicle to each of the two or more roadside apparatuses.

5. The method according to claim 1, wherein the outputting of the notification includes, when the terminal apparatus receives two or more notifications from two or more roadside apparatuses, respectively, outputting only a notification that is selected, from among the two or more notifications, based on a driving situation of the automated driving vehicle and a positional relationship of each of the two or more roadside apparatuses relative to the travel route.

6. The method according to claim 5, wherein the outputting of only the selected notification includes, when the driving situation of the automated driving vehicle is straight ahead, outputting only a notification from, among the two or more roadside apparatuses, a roadside apparatus located on either one of left and right sides with respect to the travel route of the automated driving vehicle.

7. The method according to claim 5, wherein the outputting of only the selected notification includes, when the driving situation of the automated driving vehicle is a right turn, outputting only a notification from, among the two or more roadside apparatuses, a roadside apparatus located on a right side with respect to the travel route of the automated driving vehicle.

8. The method according to claim 1, wherein the outputting of the notification includes displaying only a notification from a roadside apparatus that satisfies an output condition that can be set in the terminal apparatus based on a positional relationship of the roadside apparatus relative to the travel route of the automated driving vehicle, and not outputting a notification from a roadside apparatus that does not satisfy the output condition.

9. The method according to claim 8, wherein the output condition that can be set in the terminal apparatus includes a first output condition that a roadside apparatus is installed on a left side with respect to the travel route of the automated driving vehicle, and a second output condition that a roadside apparatus is installed on a right side with respect to the travel route of the automated driving vehicle.

10. The method according to claim 1, wherein
the notification from the roadside apparatus includes information on a pedestrian detected from video of a camera provided in the roadside apparatus, and
the method further comprises outputting the notification in a manner according to the information on the pedestrian.

11. A system comprising:
a terminal apparatus; and
a roadside apparatus,
wherein
the roadside apparatus is configured to transmit a notification to the terminal apparatus, upon detecting, from video of a camera provided in the roadside apparatus, a pedestrian who is about to cross a roadway, and
the terminal apparatus is configured to, upon receiving the notification from the roadside apparatus, identify a positional relationship of the roadside apparatus relative to a travel route of an automated driving vehicle associated with the terminal apparatus, and output the notification in a manner according to the identified positional relationship.

12. The system according to claim 11, wherein the terminal apparatus is configured to, upon receiving two or more notifications from two or more roadside apparatuses, respectively, output the two or more notifications in order that is determined based on a distance from the automated driving vehicle to each of the two or more roadside apparatuses.

13. The system according to claim 12, wherein the terminal apparatus is configured to display the two or more notifications side by side in a vertical direction or a horizontal direction on a screen of the terminal apparatus, in increasing order of the distance from the automated driving vehicle to each of the two or more roadside apparatuses.

14. The system according to claim 12, wherein the terminal apparatus is configured to audibly output the two or more notifications in increasing order of the distance from the automated driving vehicle to each of the two or more roadside apparatuses.

15. The system according to claim 11, wherein the terminal apparatus is configured to, upon receiving two or more notifications from two or more roadside apparatuses, respectively, output only a notification that is selected, from among the two or more notifications, based on a driving situation of the automated driving vehicle and a positional relationship of each of the two or more roadside apparatuses relative to the travel route.

16. The system according to claim 15, wherein when the driving situation of the automated driving vehicle is straight ahead, the terminal apparatus is configured to output only a notification from, among the two or more roadside apparatuses, a roadside apparatus located on either one of left and right sides with respect to the travel route of the automated driving vehicle.

17. The system according to claim 15, wherein when the driving situation of the automated driving vehicle is a right turn, the terminal apparatus is configured to output only a notification from, among the two or more roadside apparatuses, a roadside apparatus located on a right side with respect to the travel route of the automated driving vehicle.

18. The system according to claim 11, wherein the roadside apparatus is configured to transmit the notification to the automated driving vehicle when the roadside apparatus satisfies a notification condition that can be set in the roadside apparatus based on a positional relationship of the roadside apparatus relative to the travel route of the automated driving vehicle, and not to transmit the notification when the roadside apparatus does not satisfy the notification condition.

19. The system according to claim 18, wherein the notification condition that can be set in the roadside apparatus includes a first notification condition that a roadside apparatus is installed on a left side with respect to the travel route of the automated driving vehicle, and a second notification condition that a roadside apparatus is installed on a right side with respect to the travel route of the automated driving vehicle.

20. The system according to claim 11, wherein
the notification includes information on the pedestrian, and
the terminal apparatus is configured to output the notification in a manner according to the information on the pedestrian.
